(19) United States
(12) Patent Application Publication
(10) Pub. No.: US 2026/0307590 A1
(43) Pub. Date: Oct. 8, 2026

(54) A LOAD CARRYING PLATFORM FOR A VEHICLE

(71) Applicant: Rhino Rack Australia Pty Limited, New South Wales (AU)

(72) Inventor: Tarek Alfakhrany, New South Wales (AU)

(21) Appl. No.: 19/481,223

(22) PCT Filed: Mar. 25, 2024
(86) PCT No.: PCT/AU2024/050274

§ 371 Date: Nov. 4, 2025

(30) Foreign Application Priority Data
May 5, 2023 (AU) 2023901352

(51) Int. Cl. B60R 9/05

(52) U.S. Cl. CPC B60R 9/05

(57) ABSTRACT

A load carrying platform for mounting on a vehicle is described, the platform being generally rectangular and including: a front region, two side regions, a rear region, and a centrally disposed load carrying region, so that when installed on a vehicle the front region faces in the direction of travel of the vehicle; the front region of the platform includes a leading edge, and the cross-sectional profile of the leading edge includes a generally rounded nose region; the gradient of the leading edge changes gradually in a direction rearwardly from the nose region both above and below the nose region, commencing at a vertical gradient and transitioning to upper and lower horizontal surfaces.

### TECHNICAL FIELD

This disclosure relates in general to load carrying platforms for vehicles.

### Background to the Disclosure

In order to expand the load carrying options for a vehicle it is common to fit a load carrying platform to the vehicle. The platform is typically fitted to the roof of the vehicle. Items can then be carried on the platform thus maximising the available internal space of the vehicle for passengers and other items.

After fitting a load carrying platform to a vehicle it is sometimes found that the platform can generate wind noise when the vehicle is travelling at speed. After time, the wind noise may become annoying to vehicle occupants.

With the advent of quieter vehicles, such as electric vehicles, it has been found that even a low level of noise generated by a roof mounted platform can have an impact on the comfort of vehicle occupants.

It has been tried to fit remedial accessories to reduce wind noise such as wind fairings or deflectors. Whilst they can be effective, they add to the weight of the load carrying device and add to the overall cost of the load carrying solution.

There remains a need to provide load carrying platforms for vehicles which generate less wind noise.

### SUMMARY OF THE DISCLOSURE

In a first aspect the present disclosure provides a load carrying platform for mounting on a vehicle, the platform being generally rectangular and including: a front region, two side regions, a rear region, and a centrally disposed load carrying region, so that when installed on a vehicle the front region faces in the direction of travel of the vehicle; the front region of the platform includes a leading edge, and the cross-sectional profile of the leading edge includes a generally rounded nose region; the gradient of the leading edge changes gradually in a direction rearwardly from the nose region both above and below the nose region, commencing at a vertical gradient and transitioning to upper and lower horizontal surfaces.

The foremost tip of the rounded nose region may be located above the lower horizontal surface at a height of about one third of the distance between the upper and lower horizontal surfaces.

The front of the platform may include a trailing edge, and the cross-sectional profile of the trailing edge includes a tapered tail region.

The upper horizontal surface may commence at a point which is about one quarter of the distance from the tip of the nose region to the tip of the tail region.

The lower horizontal surface may commence at a point which is about one eighth of the distance from the tip of the nose region to the tip of the tail region.

The rearmost tip of the tail region may be located above the lower horizontal surface at a height of about four fifths of the distance between the upper and lower horizontal surfaces.

The front region of the platform may include a front member, the rear region of the platform may include a rear member and the platform region may include several spaced apart platform members which extend between the front member and the rear member, and the trailing edge may be formed from several trailing edge segments which are disposed between the platform members.

The trailing edge segments may be provided by infill components which are located adjacent to the front member and in between the platform members.

The platform may further include a number of cross members which are located below the platform members.

The cross members may include leading edges and the cross-sectional profile of the leading edges may include a generally rounded nose region.

### BRIEF DESCRIPTION OF THE DRAWINGS

Embodiments will now be described, by way of example only, with reference to the accompanying drawings, in which:

FIG. 1 is a perspective view of a load carrying platform;

FIG. 2 is a detail view of region A of FIG. 1 with a corner piece and side rail removed;

FIG. 3 is a top view of the platform of FIG. 1;

FIG. 4 is a side view of the load carrying platform of FIG. 1;

FIG. 5 is a side view of the region B of FIG. 2 with a corner piece and side rail removed;

FIG. 6 is an enlarged view of the front member of FIG. 4;

FIG. 7 is a side view of the load carry platform of FIG. 1 affixed to the roof of a vehicle;

FIG. 8 is a computational fluid dynamics plot of an arrangement of the platform of FIG. 1 attached to a vehicle; and

FIG. 9 is another plot of the same platform on another similar vehicle and viewed from a different angle.

### DETAILED DESCRIPTION OF EMBODIMENTS

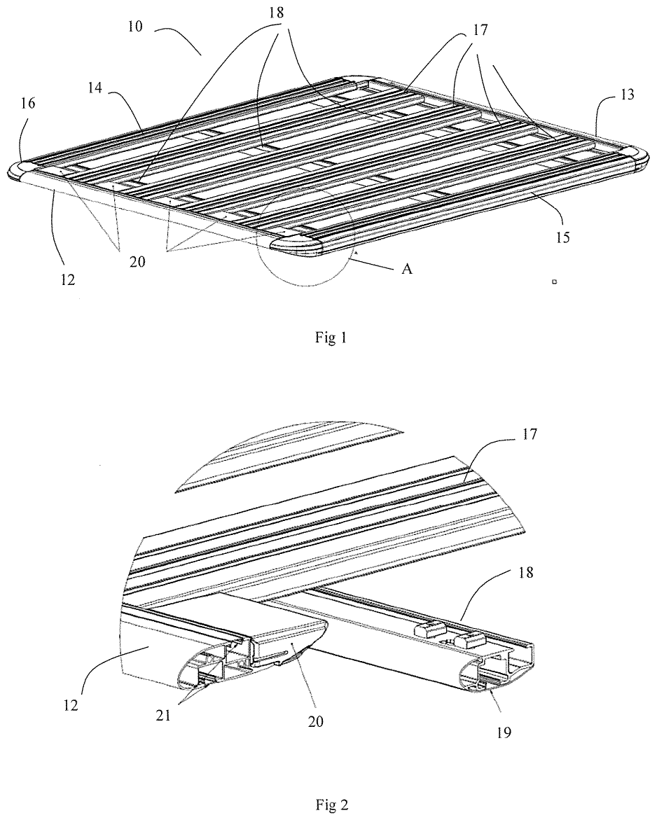

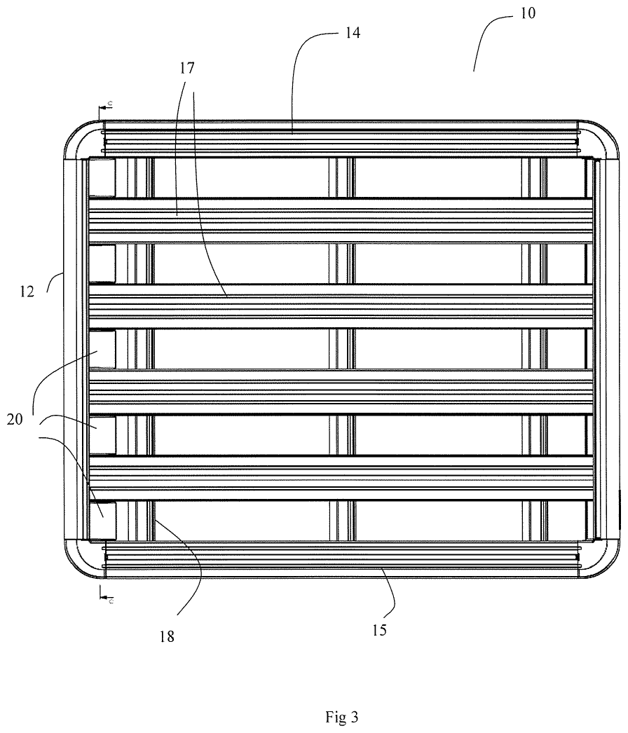

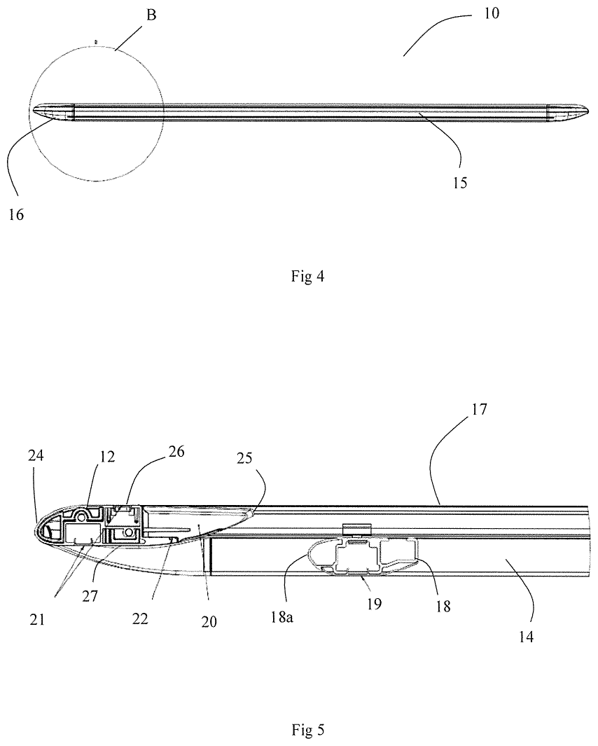

Referring to FIGS. 1 to 5, a load carrying platform 10 is shown for mounting on a vehicle (not shown). Platform 10 includes a rectangular frame formed from front member 12, two side members 14, 15 and a rear member 13. Each of the members are joined by corner mouldings 16.

A series of platform members 17 extend between the front and rear members 12, 13. The platform members sit on supporting flanges 22 (see FIG. 5) of the front and rear members 12, 13 and are attached by screw fasteners. The upper surfaces of the side members and the platform members include channels which can be used to attach fixtures and brackets to secure loads on the platform.

Three cross members 18 are attached to the undersides of the platform members and the side members. The cross members are then in turn attached by mounting brackets (not shown) to a vehicle in use. The platform 10 is fitted to a vehicle so that the front member 12 faces forwards in the direction of travel of the vehicle. A series of five identical infill components 20 are located at the rear of the front member 12 in the spaces between the platform members 17.

Referring to FIG. 5, the front region of the platform has a leading edge formed on front member 12 which includes a generally rounded nose region 24. The gradient of the leading edge changes gradually in a direction rearwardly from the nose region both above and below the nose region, commencing at a vertical gradient and transitioning to a upper and lower horizontal surfaces 26, 27.

The front region also includes a trailing edge which is formed by the series of infill components 20. Each of the infill components includes a tapered tail region 25. The infill components are supported by the same flange 22 that supports the platform members on the front member 12.

Each of the cross members 18 also include a leading edge having a rounded nose region 18a.

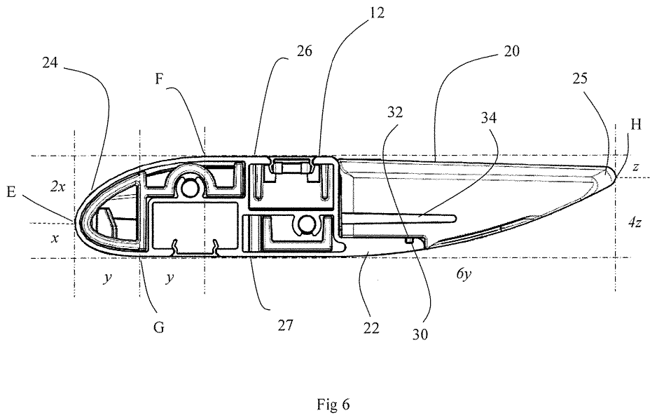

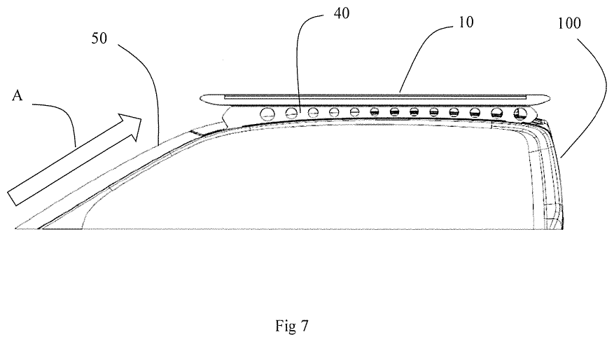

The infill components are installed between the platform members 17 at the time of assembling the platform. Referring to FIG. 6, each infill component 20 is supported on flange 22. A rib 32 on the infill component engages with a slot 30 formed in the flange 22 to prevent longitudinal movement of the infill component. Slots 34 provided on either side of the infill components 20 engage with ribs formed in the sides of the platform members to prevent vertical movement of the infill components.

Referring still to FIG. 6, the foremost tip of the rounded nose region E is located above the lower horizontal surface 27 by a distance x. The tip is located below the upper horizontal surface 26 by a distance 2x. The tip E is therefore located at a height of one third of the distance between the upper and lower horizontal surfaces 26, 27.

The transition of the gradient of the nose region to the upper horizontal surface 26 is completed at point F which marks the commencement of the upper horizontal surface. Point F is a distance of 2y from the tip E of the nose 25. Point F is a distance of 6y from the tip H of the tail 25. Point F is therefore located one quarter of the distance from the tip of the nose region to the tip of the tail region.

The transition of the gradient of the nose region to the lower horizontal surface 27 is completed at point G which marks the commencement of the upper horizontal surface. Point G is a distance of y from the tip E of the nose 25. Point G is a distance of 7y from the tip H of the tail 25. Point G is therefore located one eighth of the distance from the tip of the nose region to the tip of the tail region.

The rearmost tip of the tail region H is located above the lower horizontal surface 27 by a distance of 4z. The tip H is located below the upper horizontal surface 26 by a distance z. The tip H is therefore located at a height of four fifths of the distance between the upper and lower horizontal surfaces 26, 27.

Referring now to FIG. 7, platform 10 is shown affixed to the roof region of a vehicle 100 by way of a pair of side brackets 40 (one visible in foreground) which engage with the vehicle roof and with the cross members 18.

The profile of the leading and trailing edges described above is shaped to minimise noise which can be created by the load carrying platform as the vehicle 100 moves forward at speed. As the vehicle moves forwards, an uprush of air A is deflected upwards by the windshield region of the vehicle as the vehicle moves through air.

The gradually rounded shape of the nose 25 promotes laminar air flow and aims to delay the onset of flow separation from the top of the front profile and thereby reducing unsteady and noisy turbulent flow.

Furthermore, the tip E of the nose 25 is located at a height closer to the lower horizontal surface of the front member than the upper horizontal surface. In this way, the nose portion 25 meets the uprush of air A and encourages the air to continue to flow upwardly and rearwardly away from the front region of the platform, thereby moving any turbulent flow regions upwards and away from vehicle occupants. This aids in reducing the noise in the cab of the vehicle by ensuring that any pockets of turbulent flow are located away from the vehicle occupants.

Similarly, the tapered tail region is located at a height near to the upper horizontal surface region of the front member. This encourages airflow that passes beneath the tail section to be directed upwards as it leaves the tail region to further assist in directing the flow of air upwards and away from the vehicle.

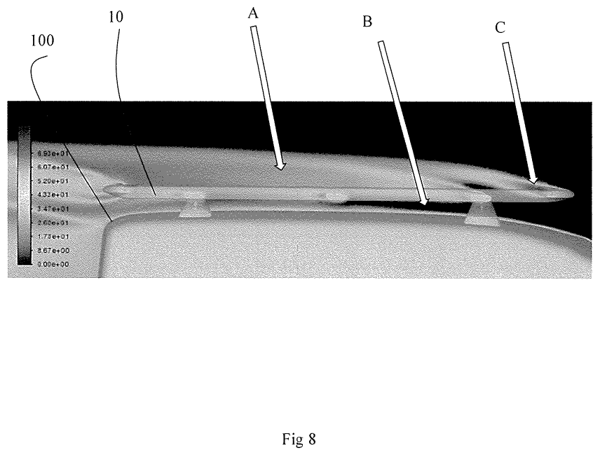

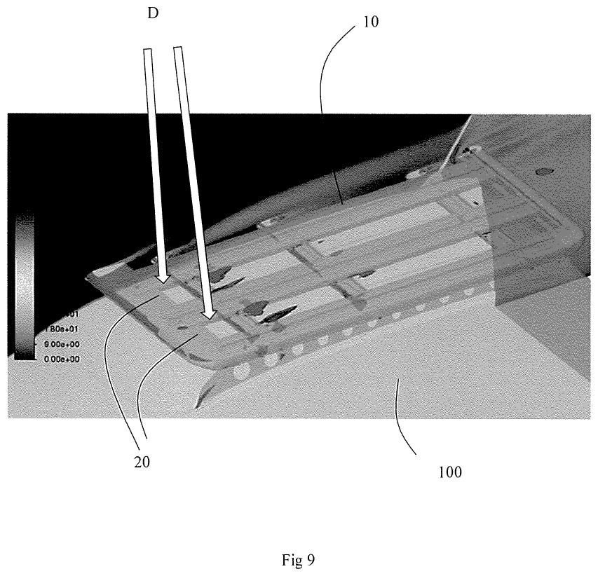

Referring to FIG. 8, a CFD (computational fluid dynamics) plot of the platform 10 attached to a vehicle 100 is shown. The plot is created in software and predicts the sound power caused by fluid flow from air rushing up from the windshield region of the vehicle and past the platform. The shade of the represented airflow varies with the calculated sound power at each location in the diagram. Of note in the drawing is a large region of laminar flow B with very low sound pressure in the region between the platform and the vehicle. The area A shows moderately turbulent air that has been directed to flow upwardly of the vehicle. A small turbulent region C is seen at the point where the airflow leaves the tail portion of the trailing edge of the front member.

Referring to FIG. 9, another CFD plot is shown, this time an orthogonal view of the left hand half of the platform 10. Of particular interest in this diagram is the absence of any shading in the region just to the rear of the infill components 20 indicated by arrows D which signifies a predicted region of very low sound pressure in this region.

The performance predicted by the CFD analysis shows that embodiments of the invention provide for load carrying platforms which generate low levels of noise in the cabin of the vehicle arising due to wind noise created by the load carrying platform.

While the disclosure has been described with reference to exemplary preferred embodiments above, it will be appreciated by those of ordinary skilled in the art that it is not limited to those embodiments, but may be embodied in many other forms, variations and modifications other than those specifically described. This disclosure includes all such variation and modifications. The disclosure also includes all of the steps, features, components and/or devices referred to or indicated in the specification, individually or collectively and any and all suitable combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description and apply throughout. Unless otherwise defined, all other scientific and technical terms used herein have the same meaning as commonly understood to one of ordinary skill in the art to which the disclosure belongs.

Any promises made in the present document should be understood to relate to some embodiments of the disclosure, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

In the foregoing description of certain embodiments, specific terminology has been resorted to for the sake of clarity. However, the disclosure is not intended to be limited to the specific terms so selected, and it is to be understood that a specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A load carrying platform for mounting on a vehicle, the platform being generally rectangular and including:
a front region, two side regions, a rear region, and a centrally disposed load carrying region, so that when installed on a vehicle the front region faces in the direction of travel of the vehicle;
the front region of the platform includes a leading edge, and the cross-sectional profile of the leading edge includes a generally rounded nose region;
the gradient of the leading edge changes gradually in a direction rearwardly from the nose region both above and below the nose region, commencing at a vertical gradient and transitioning to upper and lower horizontal surfaces.

2. A load carrying platform according to claim 1 wherein the foremost tip of the rounded nose region is located above the lower horizontal surface at a height of about one third of the distance between the upper and lower horizontal surfaces.

3. A load carrying platform according to claim 2 wherein the front of the platform includes a trailing edge, and the cross-sectional profile of the trailing edge includes a tapered tail region.

4. A load carrying platform according to claim 3 wherein the upper horizontal surface commences at a point which is about one quarter of the distance from the tip of the nose region to the tip of the tail region.

5. A load carrying platform according to claim 3 wherein the lower horizontal surface commences at a point which is about one eighth of the distance from the tip of the nose region to the tip of the tail region.

6. A load carrying platform according to claim 3 wherein the rearmost tip of the tail region is located above the lower horizontal surface at a height of about four fifths of the distance between the upper and lower horizontal surfaces.

7. A load carrying platform according to claim 1, wherein the front region of the platform includes a front member, the rear region of the platform includes a rear member and the platform region includes several spaced apart platform members which extend between the front member and the rear member, and the trailing edge is formed from several trailing edge segments which are disposed between the platform members.

8. A load carrying platform according to claim 7 wherein the trailing edge segments are provided by infill components which are located adjacent to the front member and in between the platform members.

9. A load carrying platform according to claim 7 further including a number of cross members which are located below the platform members.

10. A load carrying platform according to claim 9 wherein the cross members include leading edges and the cross-sectional profile of the leading edges includes a generally rounded nose region.
